(19) United States
(12) Patent Application Publication
(10) Pub. No.: US 2004/0098511 A1
(43) Pub. Date: May 20, 2004

(54) Packet routing method and system that routes packets to one of at least two processes based on at least one routing rule

(76) Inventors: David H. Lin, Santa Clara, CA (US); Wan-Yen Hsu, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/298,493

(22) Filed: Nov. 16, 2002

(51) Int. Cl. G06F 15/16

(52) U.S. Cl. 709/249

(57) ABSTRACT

Packet routing method and system that routes packets to one of at least two processes based on at least one routing rule for processing packets from network traffic. First, at least one routing rule is received. The routing rule specifies one or more packet criteria (e.g., network card through which the packet is received or a predetermined source address of the packet). The routing rule also specifies a predetermined route or path for packets that meet the criteria described previously. Second, packets are received from a source (e.g., network traffic). Third, the routing rule is applied to the received packets. When the packet matches the criteria, the packet is routed to a predetermined process (e.g., a first application) through a corresponding route or path. The predetermined process then performs further packet processing on the routed packet. Otherwise, the packet is routed to a predetermined process (e.g., a second application) through a predetermined route.

### FIELD OF THE INVENTION

The present invention relates generally to packet processing, and more particularly, to a packet routing method and system that routes packets to one of at least two processes based on at least one routing rule.

### BACKGROUND OF THE INVENTION

There are many packet processing applications that are used to process packets received from a network. For example, one commonly employed packet processing application filters unwanted or undesirable packets. This application is commonly referred to as a firewall product. The firewall product is particularly helpful in blocking or filtering out unwanted types of network traffic (e.g., dropping un-wanted packets). For example, if it is determined that a hacker is attempting to illegally access information from a particular company, and the source address of the hacker is known, the firewall product can be configured to block all traffic from the hacker as defined by the source IP address.

In another example, the firewall product can be configured to block all electronic mail from a particular source address (e.g., SPAM traffic), thereby reducing network congestion. In yet another example, the firewall product can be configured to block all web traffic from a web site with objectionable content.

In these packet filtering applications, only a single stream of traffic can be processed. In other words, the prior art approach utilizes a single processor to process the packets that are received from the network.

For example, traffic enters as a single input and leaves as a single output. In this manner, only a single processor can be utilized to process the traffic. Although this configuration may be tolerable for most firewall products, there are other situations and other applications where the processing power of a single processor is insufficient.

Even as the speed and power of processors increase, there are certain applications for which a single processor solution with its limited processing power is insufficient. The use of a single CPU is disadvantageous and inflexible in that the performance of a single CPU may be too slow and prone to packet loss for certain packet-intensive processing application. It is noted that this approach may suffer from a performance point of view due to the limited processing power of a single CPU. When the packets cannot be processing in a timely manner, the packets are dropped or lost. This situation can greatly impair performance and may not be acceptable for many applications, especially for applications that require an accurate accounting of network packets.

Moreover, in many systems that include multiple processing units (e.g., multiple central processing units (CPUs)), the processing power cannot harnessed or utilized by these programs.

Based on the foregoing, there remains a need for a method and system for processing packets that reduce packet loss, leverage the processing power of multiple-processor systems, and that overcome the disadvantages of the prior art as set forth previously.

### SUMMARY OF THE INVENTION

According to one embodiment of the present invention, a packet routing method and system that routes packets to one of at least two processes based on at least one routing rule is described.

According to another embodiment of the present invention, a method for routing packets based on at least one rule is described. First, at least one routing rule is received. The routing rule specifies one or more packet criteria (e.g., network card through which the packet is received or a predetermined source address of the packet). The routing rule also specifies a predetermined route or path for packets that meet the criteria described previously. Second, packets are received from a source (e.g., network traffic). Third, the routing rule is applied to the received packets. When the packet matches the criteria, the packet is routed to a predetermined process (e.g., a first application) through a corresponding route or path. The predetermined process then performs further packet processing on the routed packet. Otherwise, the packet is routed to another predetermined process (e.g., a second application) through a default route or another predetermined route.

According to another embodiment of the invention, a system for selectively routing packets based on at least one routing rule is described. The system includes a rule configuration mechanism for providing a user interface that allows a user to define one or more routing rules. The system also includes a routing mechanism for routing packets to one of at least a first process and a second process based on the routing rules defined previously. In a system that has more than one processor, the processes can be distributed among different processors. For example, the first process may be executed by a first processor, and the second process may be executed by a second processor.

Other features and advantages of the present invention will be apparent from the detailed description that follows.

### BRIEF DESCRIPTION OF THE DRAWINGS

The present invention is illustrated by way of example, and not by way of limitation, in the figures of the accompanying drawings and in which like reference numerals refer to similar elements.

FIG. 1 illustrates a system in which the rule-based routing mechanism (RRM) according to one embodiment of the present invention can be implemented.

FIG. 2 is a block diagram illustrating in greater detail the rule-based routing mechanism (RRM) of FIG. 1 according to one embodiment of the present invention.

FIG. 3 is a block diagram illustrating the rule-based routing mechanism (RRM) of FIG. 1 implemented in a network server according to one embodiment of the present invention.

FIG. 4 is a flow chart illustrating the steps performed by the rule-based routing mechanism (RRM) of FIG. 1 in accordance with one embodiment of the present invention.

FIG. 5 illustrates an electronic mail processing application that utilizes the rule-based routing mechanism (RRM) in accordance with one embodiment of the present invention.

### DETAILED DESCRIPTION

A rule-based routing method and system for selectively routing packets to a first process or a second process based on at least one routing rule. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

It is noted that aspects of the present invention are described in connection with packets that conform to the Transmission Control Protocol/Internet Protocol (TCP/IP). However, it is to be appreciated that the teachings of the present invention extend to packets that conform to different formats and protocols.

System 100

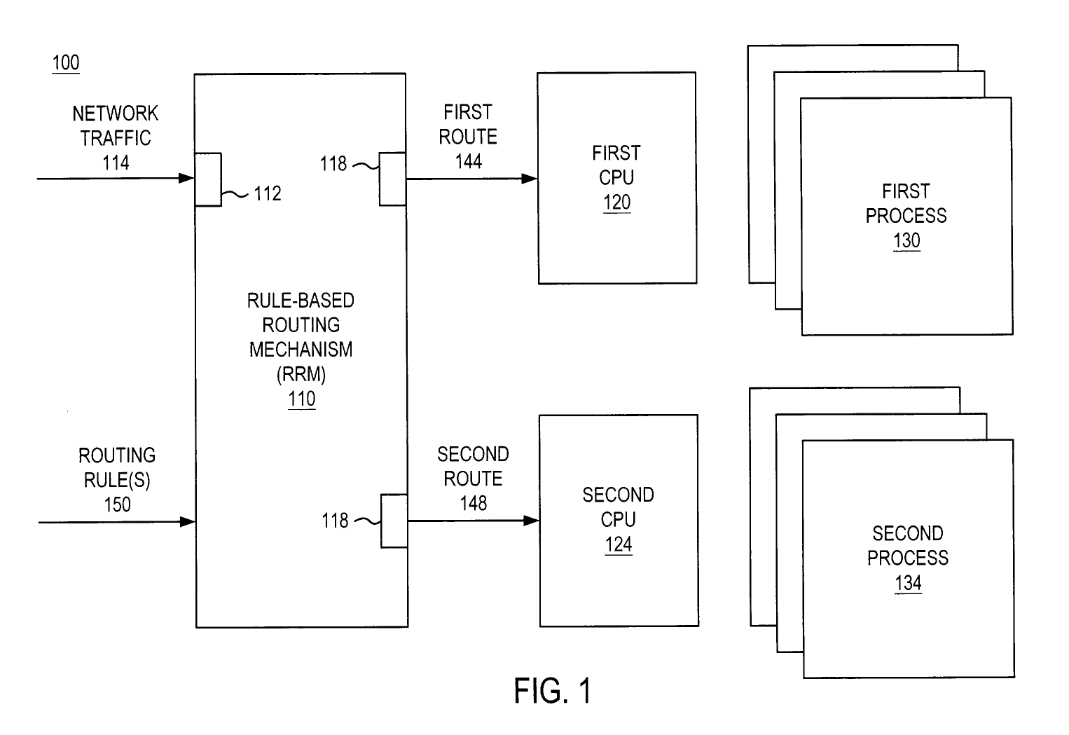

FIG. 1 illustrates a system 100 in which the rule-based routing mechanism (RRM) 110 according to one embodiment of the present invention can be implemented. The system 100 includes the rule-based routing mechanism (RRM) 110, a plurality of processors (e.g., a first processor (CPU) 120 and a second processor (CPU) 124), and a plurality of processes (a first process 130 and a second process 134) executing on the processors. The term process as used herein refers to an instance of any application (e.g., an instance of the same application or a different application). The process can have its own data or can share data with other processes in which case the process is commonly referred to as a “thread.”

The rule-based routing mechanism (RRM) 110 includes an input 112 for receiving, for example, a single stream of network traffic 114 and at least two outputs 118 (e.g., multiple outputs that are coupled to different destinations). For example, there is a first output coupled to the first processor 120 through a first route 144 or path and a second output coupled to the second processor 124 through a second route or path 148. The rule-based routing mechanism (RRM) 110 also receives one or more routing rules 150. The rule-based routing mechanism (RRM) 110 delivers or routes the packets received on the input 112 to one of the two outputs based on one or more routing rules 150.

Network traffic 114 can include packets of information. Each packet is typically divided into a plurality of fields, whose function could be defined by a predetermined protocol. The routing rules 150 can specify one or more fields for comparison with predetermined values (e.g., one or more fields in the header of an incoming packet) to determine a particular route for a particular packet. The routing rules and examples of such rules are described in greater detail hereinafter with reference to TABLES I-IV.

One aspect of the invention is that these routing rules are configurable by a user. An exemplary routing rule is to intercept only those packets that come from a particular network card. For example, a server may have multiple network cards that each provides respective network traffic of packets. Network card selection rules provide one or more output traffic that can be, for example, limited to those packets that come from a first network card. A user can configure the network card selection rules to route only packets that come from a particular network card or a group of network cards.

The rule-based routing mechanism (RRM) 110 determines the destinations of the packets based on at least one routing rule 150. The routing rule 150 specifies a packet's data or characteristics. For example, the selection can be based on a network interface identifier (e.g., a tag specifying a network card through which a packet is received), a portion of the header of the packet (e.g., the TCP header, the IP header, or IP address field), a portion of the data of the packet, a MAC address field, one or more an aggregated user-defined field, etc.

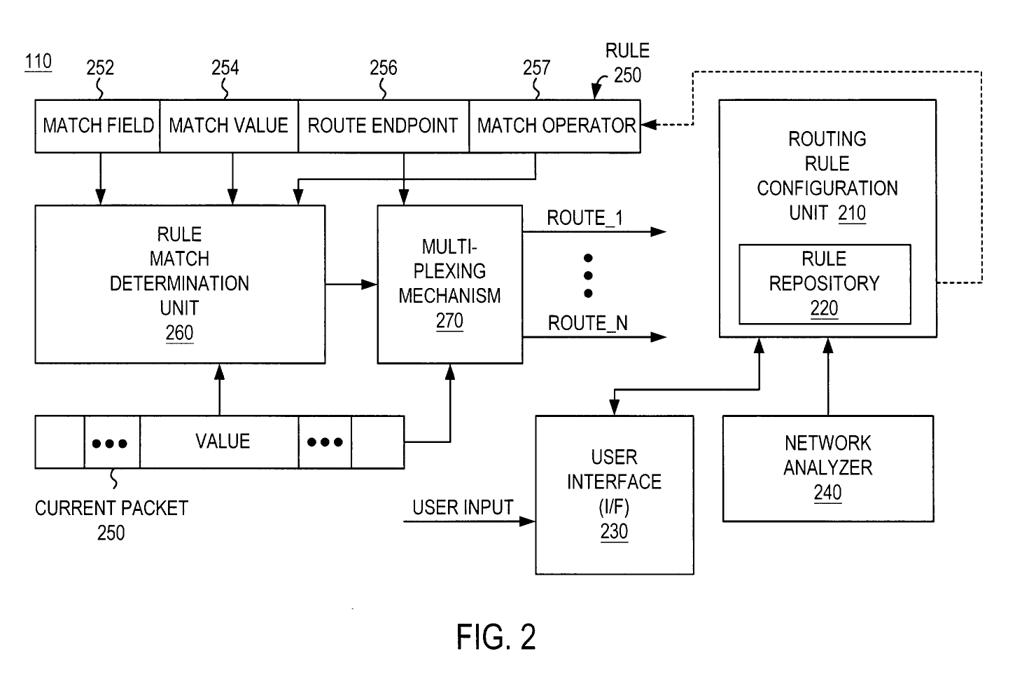

Based on the selection criteria, the rule-based routing mechanism (RRM) 110 routes or diverts the packets to different outputs 118. Although only two outputs 118 are illustrated, it is noted that there can be any number of output destinations, where the number of destinations can be tailored to suit a particular application. The rule-based routing mechanism (RRM) 110 is also referred to herein also as a selection mechanism and is described in greater detail hereinafter with reference to FIG. 2.

It is noted that in other embodiments, the rule-based routing mechanism (RRM) 110 can include multiple inputs for accommodating multiple input streams.

One advantage of the rule-based routing mechanism (RRM) 110 according to the invention is that more than one processor (e.g., central processing unit (CPU)) can be assigned to each output, thereby achieving scalability and parallelism. Another advantage of the rule-based routing mechanism (RRM) 110 according to the invention is that more processors can be added to a system when there is more traffic to be processed, thereby reducing packet loss for packet-intensive processing applications.

Rule-Based Routing Mechanism (RRM)

FIG. 2 is a block diagram illustrating the rule-based routing mechanism (RRM) 110 of FIG. 1 in greater detail according to one embodiment of the present invention. The RRM 100 includes a routing rule configuration unit 210 for configuring one or more routing rules (e.g., rule 250). For example, an administrator can use the routing rule configuration unit 210 to configure one or more packet routing rules. For example, an administrator can specify a rule to route all HTTP packets coming from a specific network interface card to a specific process.

The RRM 100 can also include a user interface 230 for receiving user input to add, delete, or modify one or more routing rules. The rule configuration unit 210 can also receive rules from another software component or hardware device (e.g., network analyzer 240).

The rule configuration unit 210 includes a rule repository 220 for storing the routing rules. A first exemplary routing rule can specify a particular route or process that is based on the type of traffic of the packet. A header of a packet typically includes fields that specify whether the packet is an electronic mail, a Web page (HTTP), or a file transfer protocol (FTP) packet, or other type of data.

Another exemplary rule can specify that only packets from a particular sender or targeted for a particular receiver are of interest. This routing rule may be applied to one or more fields in the header of the packet that specify the IP address of the sender or the recipient of the packet. As described in further detail hereinafter, a rule that selects packets based on the sender or receiver may be important to certain applications.

It is noted that a routing rule can be applied to any portion of a packet. For example, a rule can be applied to one or more bytes of the IP header or the TCP header. In web traffic, the packets include an HTTP header, which can include one or more byte that may be the subject of a rule.

It is further noted that a routing rule may be applied only to one or more header fields, only to one or more application tag fields, or applied to one or more header fields in combination with one or more application tag fields. The application tag fields and the number of bytes in each of the tag fields may be configurable by the user to meet the requirements of the particular application.

In one embodiment, each rule 250 includes a match field 252, a match value 254, a route end point 256, and a match operator 257. The match field 252 specifies the field in the packet (e.g., one or more bytes of the packet) to which the rule applies. The match value 254 specifies a predetermined value or range of values for use in comparison with the value in the match field of the current packet. The route end point 256 specifies the destination (e.g., processor and/or application or process) to which packets that satisfy the rule are sent or directed. The match operator 257 determines the comparative relationship (e.g., equal to, not equal to, greater than, less than, etc.) between the match field and the match value.

The RRM 100 includes a rule match determination unit 260 for applying rules (e.g., routing rules that are pre-determined and pre-configured by a user) to the current packet. For example, the rule match determination unit 260 applies the match operator 257 to the match value 254 and the value in the field of the current packet 250, specified by the match field 252. When a packet meets or matches one or more of the rules, the packet is selected for routing to a particular process identified by the routing rule.

The RRM 100 includes a multiplexing mechanism 270 for selectively routing the current packet to one of a plurality of outputs or routes based on the output of the rule match determination unit 260. The outputs (e.g., route_{—}1 to route_N) of the multiplexing mechanism 270 can be coupled to a different processors or processes.

It is noted that a default process or processor may be provided for those rules that do not have a route endpoint specified or for situations where there is a single rule, and the rule is not met. It is further noted that one of the routes may not be coupled to any process (i.e., the packets sent to this route are dropped).

Network Server 300 With Integrated IP Filter

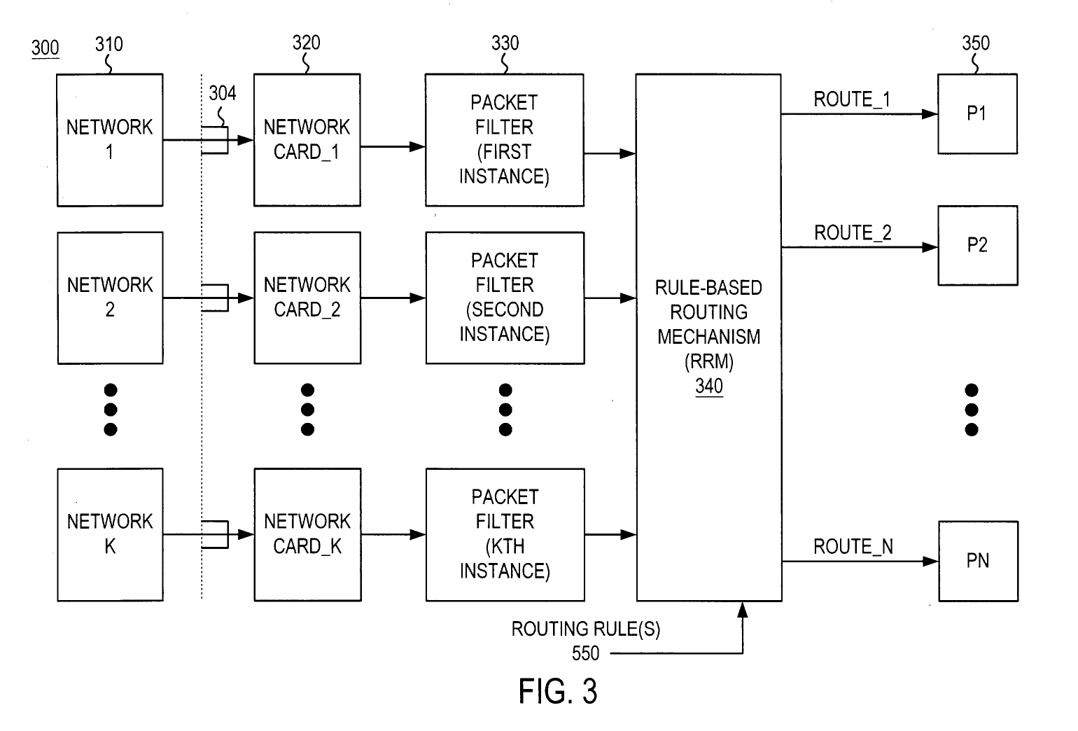

FIG. 3 illustrates a system 300 in which the rule-based routing mechanism (RRM) according to one embodiment of the present invention is implemented with a packet filter. In this embodiment, the system 300, which can be a network server, includes a plurality of network connections 304 (e.g., input ports) 304 that are coupled to a corresponding plurality of networks 310 (e.g., network_{—}1, network_{—}2, . . . , network_k). Examples of the networks 310 include, but are not limited to, local area networks (LANs) and optical fiber networks. The network server 300 also includes a plurality of network cards 320 (e.g., network card_{—}1, network card_{—}2, . . . , network card_K) that interface with a particular network 310. In one example, there is a network card (e.g., an Ethernet card, a gigabit card, or a wireless card for processing wireless traffic) corresponding to each network. However, there are other possible configurations, where a network card can be coupled to more than one network.

In this example, the network server 300 includes a plurality of packet filters 330 (e.g., packet filter instances) that are each associated with a corresponding network card. The packet filter instance can be provided with a stream of packets. The packet filter 330 selectively drops packets that meet one or more filtering criteria. For example, packets that are from a predetermined source may be dropped or “filtered out” so that the packets are not processed by the server 300. For example, the packet filter 330 can be configured to block all web traffic (e.g., to drop all HTTP packets). Packet filters are generally well-known by those of ordinary skill in the art and will not be described in greater detail herein.

The network server 300 includes a rule-based routing mechanism (RRM) 340 according to the invention. In this example, each packet filter is coupled to the rule-based routing mechanism (RRM) 340. The RRM 340 routes the received packets to one of a plurality of processes 350 (P1, P2, ..., PN) based on one or more pre-configured routing rules. There may be, for example, a different route (route 1, route 2, ..., route N) from the RRM 340 to each of the different processes 350. Each of the processes 350 may be executing on a corresponding processor or one or more processes may share a single processor. The process may be a particular application that is tailored for processing the packets directed thereto. For example, when the RRM 340 is configured with a routing rule that selectively routes packets based on a network card tag field, which specifies the network card from which the packet is received, the packets are routed based on the value in the network card tag field. Based on the value in the network card tag field, the packet is routed to a predetermined processor for processing by a predetermined application or process 350.

In another example, there may be a plurality of RRMs 340, where each packet filter is coupled to a corresponding rule-based routing mechanism (RRM) 340. In this case, the routing may be based on criteria other than the network card tag. For example, the packets may be routed based on the value in the source address field or destination address field of the packet.

In one embodiment, the RRM 340 may be integrated with the packet filter 330 as a plug-in software module or an add-on component to the packet filter 330.

### Processing Performed by the Rule-based Routing Mechanism (RRM)

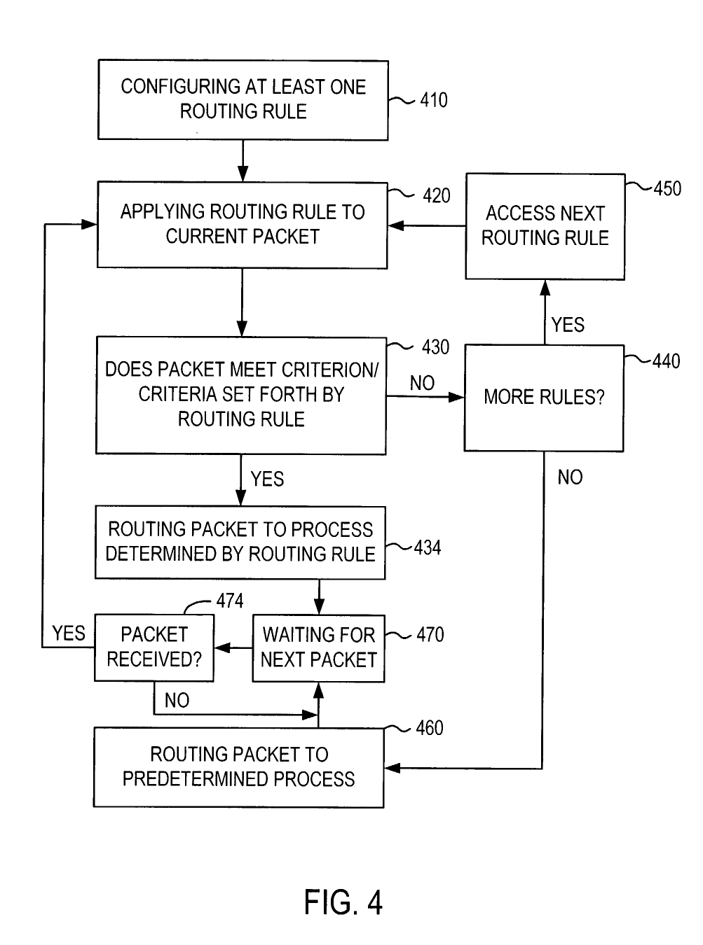

FIG. 4 is a flow chart illustrating the steps performed by the rule-based routing mechanism (RRM) 110 of FIG. 1 in accordance with one embodiment of the present invention. In step 410, routing rule configuration is performed. One or more routing rules are defined or specified and provided to the RRM 110. Examples of routing rules are described hereinafter with reference to TABLES I to IV.

In one embodiment, the routing rules may be retrieved by the RRM 110 from a configuration file that includes one or more rules (e.g., a set of routing rules) defined by a user (e.g., a system administrator). In another embodiment, the routing rules are generated by a component, such as a network analyzer, that can provide network statistics in the form of a performance summary or report. When the network analyzer determines that a particular network card is being overloaded, the network analyzer can generate a rule that diverts traffic from that network card to a special process. In another example, when the network analyzer determines that a particular destination address is receiving too much electronic mail or web traffic, the network analyzer can generate a rule that drops the packets intended for the particular destination or otherwise diverts the packet traffic to a special process.

In step 420, a first rule is applied to a current packet. In step 430, a determination is made whether the current packet matches a criterion (or criteria) set forth by the first rule. When the current packet matches a criterion set forth by the first rule, the packet is routed to a process specified by the routing rule in step 434.

Otherwise, in step 440, a determination is made whether there are more rules to apply to the current packet. When there are more rules to apply to the current packet, the next rule is accessed in step 450. Processing then continues at processing step 420 where the next rule is applied to the current packet.

When there are no more rules to apply to the packet, the packet is routed to a predetermined process in step 460. In step 470, the processing waits for a next packet. In step 474, a determination is made whether a next packet is received. When the next packet is received, processing proceeds to step 420, where the rule is applied to the received packet. When the next packet has not yet been received. processing proceeds to step 470 to wait for the next packet.

### Exemplary Fields Employed for Routing

A first field in the IP header of a packet can be utilized for packet routing. In this example, a source address field of the IP header is utilized to make a routing decision (e.g., utilized for comparison to a predetermined value or range of values). In other words, the value of the source address field of a packet is employed to determine a particular process and a particular processor for processing the packet. TABLE I illustrates an exemplary routing rule based on the source address field of the IP header.

TABLE I

| | Source Address | Destination | Process | Operator |
|---|---|---|---|---|
| Rule 1 | 119.13.11.32 | CPU 1 | Process A | = |
| Rule 2 | 119.23.22.11 | CPU 2 | Process C | != |

In this example, Rule 1 states that all network packets coming from the source address 119.13.11.32 are to be routed to Process A, which is executing on CPU 1. Rule 2 states that all other network packets not matching the source address of 119.23.22.11 are to be routed to Process C, which is executing on CPU 2.

A second field in the IP header of a packet can be utilized for packet routing In this example, a destination address field of the IP header is utilized to make a routing decision (e.g., utilized for comparison to a predetermined value or range of values). In other words, the value of the destination address field of a packet is employed to determine a particular process and a particular processor for processing the packet. TABLE II illustrates an exemplary routing rule based on the destination address field of the IP header.

TABLE II

| | Destination address | Destination | Process | Operator |
|---|---|---|---|---|
| Rule 1 | 15.13.11.32 | CPU 1 | Process A | = |
| Rule 2 | 16.23.22.11 | CPU 3 | Process D | != |

In this example, Rule 1 states that all network packets going to destination address 15.13.11.32 are to be routed to Process A, which is executing on CPU 1. Rule 2 states that all network packets not going to destination address 16.23.22.11 are to be routed to Process D, which is executing on CPU 3.

A network card tag of a packet can be for utilized for packet routing. In this example, network card tag of a packet is utilized to make a routing decision. In other words, the value of the network card tag of a packet is employed to determine a particular process and a particular processor for processing the packet. TABLE III illustrates an exemplary routing rule based on a network card tag of a packet.

TABLE III

| | Network Interface | Destination | Process | Operator |
|---|---|---|---|---|
| Rule 1 | NC_1 | CPU 1 | Process A | = |
| Rule 2 | NC_2, NC_3 | CPU 2 | Process C | = |

In this example, Rule 1 states that any network packets arriving at network interface card NC_{—}1 are to be routed to Process A, which is executing on CPU 1. Rule 2 states that any network packets arriving at network interface card NC_{—}2 or card NC_{—}3 are to be routed to Process C, which is executing on CPU 2.

A user-defined field of a packet can be utilized for packet routing. In this example, a user-defined field of a packet is utilized to make a routing decision. In other words, the value of a user-defined field of a packet is employed to determine a particular process and a particular processor for processing the packet. TABLE IV illustrates an exemplary routing rule based on a user-defined field of a packet.

TABLE IV

| | Byte offset (bits) | Destination | Process | Operator |
|---|---|---|---|---|
| Rule 1 | 0x20(8).op.0x20 | CPU 1 | Process A | = |
| Rule 2 | 0x5e(32).op.0xff | CPU 2 | Process D | > |

In this example, Rule 1 routes all packets with the field, which is delimited at byte offset of 20 (hexadecimal) in the packet with a size of 8 bits, equal to 20 (hexadecimal) to Process A, executing on CPU 1. It is noted that the “.op.” refers to the operator field which is “=” in rule 1 and “>” in rule 2. Rule 2 routes all packets with the field, which is delimited at byte offset of 5e (hexadecimal) in the packet with a size of 32 bits, greater than ff (hexadecimal) to Process D, executing on CPU 2.

### First Exemplary Application

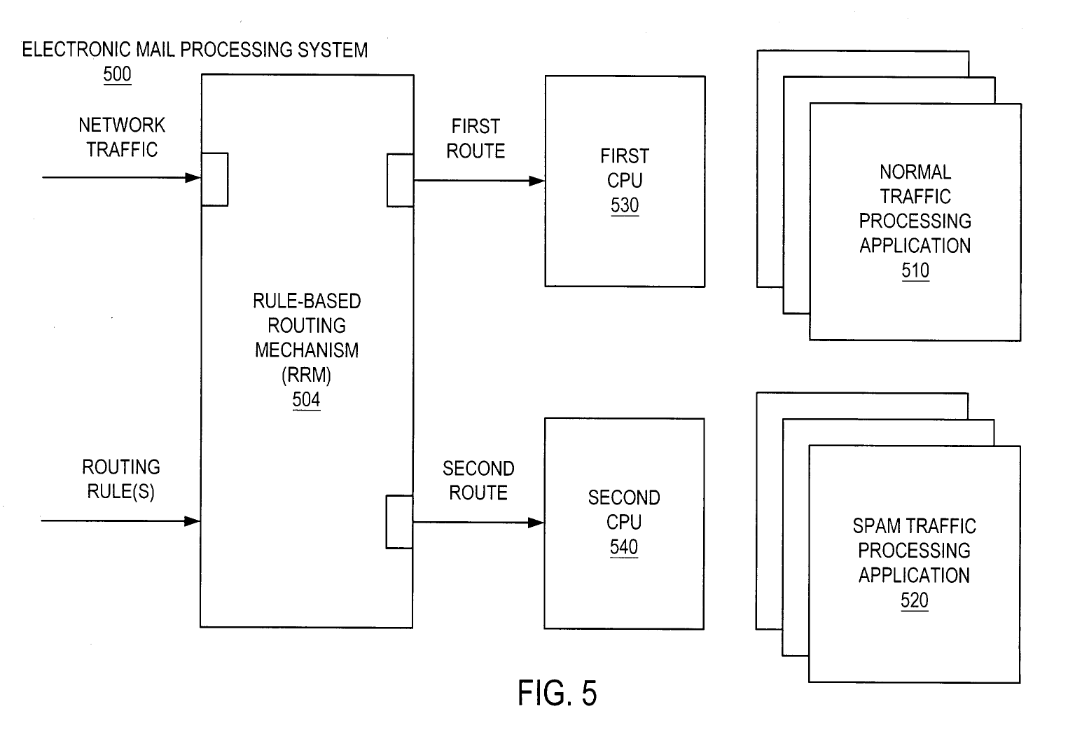

FIG. 5 illustrates an electronic mail processing application 500 that utilizes the rule-based routing mechanism (RRM) 504 in accordance with one embodiment of the present invention. The electronic mail processing application 500 includes a normal traffic processing application 510 for processing normal or standard electronic mail messages and a SPAM traffic processing application 520 for processing SPAM traffic or “junk” mail. In this example, the normal traffic processing application 510 is executing on a first processor 530, and the SPAM traffic processing application 520 is executing on a second processor 540.

This rule-based routing mechanism (RRM) 504 according to the invention can be used to divert some network traffic for special processing. For example, a user may want all traffic from site. x.x.x.x to be diverted to a different CPU (e.g., the second processor 540) for processing, thereby allowing other critical traffic to be processed in a timely fashion by the first processor 530. In this manner, rule-based routing mechanism (RRM) 504 according to the invention enables the selective routing of SPAM traffic to a special SPAM processing application.

The principles of the present invention are described in the context of a method and system for routing packets. However, it is noted that the teachings of the present invention can be applied to other information (e.g., non-network data), to network information that are organized with other protocols or models (e.g., non-TCP/IP model information) and to other types of data (e.g., non-packet data or information).

Similarly, although the principles of the present invention are described in the context of an electronic mail processing application for reducing SPAM, it is noted that the rule-based routing mechanism (RRM) according to the invention may be utilized in numerous other types of applications.

Some of these applications include:

1. Billing Applications - An Internet service provider (ISP) charges a customer based on service usage. The packet routing mechanism according to the invention can be used to filter customer traffic based on some known criteria (e.g., web surfing traffic) and route them to separate billing applications for processing.

2. Trending Applications - Trending information is useful for marketing purposes. The service provider can use this information to determine the trends of customer usage, customer preferences (e.g., favorite websites for surfing, favorite websites for downloads, favorite websites for on-line purchases, etc.) and whether a customer or subscriber is increasing or decreasing the use of a particular service. For example, a trending application can track how a customer uses a music download service. In this example, the packet routing mechanism according to the invention can be employed to route all music download packets to the trending application.

3. Data Warehousing Applications - Data warehousing is used for retrieving and storing historic data. The packet routing mechanism according to the invention can be used to route specific traffic for the purpose of data warehousing. For example, a service provider can use this information to generate a customer profile that determines the percentage of customers surfing the web. Other information, such as file transfer and download traffic history, can also be used to generate marketing data.

4. Network Monitoring and Analysis Applications - The packet routing mechanism according to the invention can be used as a network monitoring device. For example, all the electronic mail traffic can be routed by this invention to an application that checks for virus or monitors specific malicious patterns (e.g., an anti-virus application). Another example is to route all requests from a particular source to a network analysis application that intercepts and tracks or analyzes specific keywords or patterns.

5. Load balancing Applications-The packet routing mechanism according to the invention can be used as a load balancer that divides the incoming traffic to various destination based on some known criteria (e.g. source address.) The packet routing mechanism according to the invention can also accept feedback, as configurations change, from the applications to better balance the traffic load.

6. Quality of Service Applications-The packet routing mechanism according to the invention can be used for bandwidth throttling or bandwidth management. For example, if there is an excessive amount of web traffic, the packet routing mechanism according to the invention can be configured to limit amount of requests by diverting traffic to an application that introduces delay or simply drops some packets.

In the foregoing specification, the invention has been described with reference to specific embodiments thereof. It will, however, be evident that various modifications and changes may be made thereto without departing from the broader scope of the invention. The specification and drawings are, accordingly, to be regarded in an illustrative rather than a restrictive sense.

What is claimed is:

1. A method for routing packets in a system that includes a source of packets, a first process and a second process, the method comprising the steps of:
a receiving at least one routing rule for specifying at least one packet criterion and a route for packets that match the packet criterion;
b receiving packets from the source of packets; and
c applying the routing rule to the received packets.

2. The method of claim 2 wherein the step of applying the routing rule to the received packets includes
routing the packets to one of the first process and the second process based on the routing rule.

3. The method of claim 2 wherein the step of routing the packets to one of the first process and the second process based on the routing rule includes
determining whether a value in a field in the packet matches a predetermined value specified by the pakcet criterion;
when there is a match, routing the packet to the first process specified by a first route; and
when there is no match, routing the packet to the second process specified by a second route.

4. The method of claim 3 wherein the step of determining whether a value in a field in the packet matches a predeterminedvalue specified by the packet criterion includes one of
comparing a value in a network card identifier tag of the packet with a predetermined identifer;
comparing a value in a source address field of the packet with a predetermined source address;
comparing a value in a destination address field of the packet with a predetermined destination address; and
comparing a value in a user-defined field of the packet with a predetermined value.

5. The method of claim 2 wherein the first process is executed by a first processor; and wherein the second process is executed by a second processor.

6. The method of claim 1 wherein the routing rule is specified by one of a user-defined configuration file and a network analyzer.

7. The method of claim 4 wherein the user-defined field includes one of a portion of the TCP header, a portion of the IP header, a portion of the payload, and
a portion of a system-defined field of the packet.

8. The method of claim 1 wherein the first process includes one of a billing application, a trending application, a data warehousing application, a network monitoring application, a network analysis application, a load balancing application, a quality of service application, an anti-virus application, and an electronic mail processing application.

9. The method of claim 1 wherein the second process includes one of a billing application, a network analysis application, a load balancing application, a quality of service application, an anti-virus application, and an electronic mail processing application.

10. The method of claim 1 wherein the source is one of a network card, a packet generator, another process, and an external data source.

11. A method for processing packets received from a source comprising:
a receiving at least one routing rule:
b receiving a first packet from the source;
c applying the routing rule to the received first packet; and
d when the first packet matches the criteria, routing the packet to a first predetermined process (e.g., a first application) through a corresponding first route.

12. The method of claim 11 further comprising:
c when the first packet does not match the routing rule, routing the first packet to a second predetermined process through a second predetermined route.

13. The method of claim 11 further comprising:
e the first predetermined process performing further packet processing on the route packet.

14. The method of claim 11 further comprising:
routing packets of one of at least two processes based on at least one routing rule.

15. The method of claim 11
wherein the routing rule specifies at least one packet criteria and a predetermined route for packets that meet the packet criteria.

16. The method of claim 15
wherein the predetermined route for packets that meet the packet criteria includes one of a first route to a first process and a second route to a second process.

17. The method of claim 15
wherein the packet criteria includes one of a network card identifier that identifies a network card through which the packet is received, a predetermined destination address of the packet, a predetermined source address of the packet, and a predetermined value for one of the fields of the packet.

18. A system for selectively routing packets from network traffic based on at least one rule comprising:
a a routing rule configuration mechanism for providing an interface for a user to configure at least one routing; and
b a selection mechanism for selectively routing packets from network traffic to one of a first process and a second process based on at least one routing rule.

19. The system of claim 18 further including:
wherein the first process is executed by a first processor; and
wherein the second process is executed by a second processor.

20. The system of claim 18
wherein the first process includes one of a billing application, a trending application, a data warehousing application, a network monitoring application, a network analysis application, a load balancing application, a quality of service application, an anti-virus application, and an electronic mail processing application; and
wherein the second process includes one of a billing application, a trending application, a data warehousing application, a network monitoring application, a network analysis application, a load balancing application, a quality of service application, an anti-virus application, and an electronic mail processing application.
